(19) United States
(12) Patent Application Publication
(10) Pub. No.: US 2025/0230326 A1
(43) Pub. Date: Jul. 17, 2025

(54) CURABLE RESIN COMPOSITION, COATING LAYER, LAMINATE, PLASTIC LENS, AND IMAGE DISPLAY DEVICE

(71) Applicant: DAICEL CORPORATION, Osaka (JP)

(72) Inventor: Yusaku SAINOHIRA, Tokyo (JP)

(73) Assignee: DAICEL CORPORATION, Osaka (JP)

(21) Appl. No.: 18/989,674

(22) Filed: Dec. 20, 2024

(30) Foreign Application Priority Data
Jan. 17, 2024 (JP) 2024-005612

(51) Int. Cl. C09D 5/20; C08J 7/04; C09D 7/20; C09D 183/04; G02B 1/04

(52) U.S. Cl. CPC C09D 5/20; C08J 7/0427; C09D 7/20; C09D 183/04; G02B 1/041; C08J 2345/00; C08J 2483/04

(57) ABSTRACT

Problem

To provide a curable resin composition that can be applied as a single layer coating, exhibits sufficient adherence to a cycloolefin-based copolymer substrate, and is excellent in moisture resistance.

Solution

A curable resin composition of the present disclosure is a curable resin composition for coating a cycloolefin-based copolymer substrate, and includes an alicyclic ketone compound and/or an alicyclic ether compound, and a cationically polymerizable silsesquioxane and/or a cationically polymerizable cyclic siloxane. The curable resin composition of the present disclosure preferably has a viscosity of 15 mPa·s or less at 25° C.

### TECHNICAL FIELD

The present disclosure relates to a curable resin composition, a coating layer, a laminate, a plastic lens, and an image display device.

### BACKGROUND ART

In recent years, substrates made of resin have become more widely used in association with the expansion of mobile devices such as smartphones and tablet PCs. A substrate made of a resin is known to be lightweight and excellent in workability, but in comparison to inorganic materials such as glass, resin substrates exhibit lower chemical resistance, and optical characteristics are impaired due to whitening and surface roughness. In addition, the surface hardness of a substrate made of a resin is low, and thus resin substrates tend to be easily scratched, which results in a decrease in transparency. To deal with these problems when such a resin substrate is used, a technique is generally known in which the substrate surface is coated with a coating liquid that protects the resin substrate.

Cycloolefin-based polymers in particular have excellent characteristics such as high transparency, low photo elasticity, good dielectric properties, a high softening temperature, a low water absorption rate, and high water vapor barrier properties. However, a known problem of cycloolefin-based polymers is that such polymers have high resistance to acids, alkalis, and polar solvents and exhibit poor adherence even when a coating liquid is applied, and therefore it is difficult to laminate a coating film.

Patent Document 1 discloses, as a technique related to coating onto a resin substrate containing a cycloolefin-based polymer, an invention that is based on a photocurable resin composition in which an acrylic-based resin is used. Patent Document 2 discloses an invention in which an ultraviolet-curable resin containing inorganic fine particles is used as an easy-adhering layer.

### CITATION LIST

### Patent Documents

Patent Document 1: JP 2016-196653 A
Patent Document 2: JP 2023-92527 A

### SUMMARY OF INVENTION

### Technical Problem

However, in the invention described in Patent Document 1, an acrylic-based resin must be used, and in order to sufficiently cure the acrylic-based resin, polymerization must be carried out in a nitrogen atmosphere, and therefore handling ease is a problem. Another problem is that the cycloolefin-based copolymer has high chemical resistance, and thus it is difficult to achieve sufficient adherence.

The problem with the invention described in Patent Document 2 is that another layer must be laminated as an adhesive layer between the substrate and the coating layer, and when multiple layers are laminated in this manner, uniformity of the film thickness is reduced, and the optical characteristics and the like are easily impaired.

In addition, the coating layer itself is also required to exhibit excellent moisture resistance like that of a cycloolefin-based copolymer substrate.

Accordingly, an object of the present disclosure is to provide a curable resin composition that can be applied as a single layer coating, has sufficient adherence to a cycloolefin-based copolymer substrate, and exhibits excellent moisture resistance.

### Solution to Problem

As a result of intensive efforts to solve the above problems, the present inventors discovered that a curable resin composition containing an alicyclic ketone compound and/or an alicyclic ether compound and a cationically polymerizable silsesquioxane and/or a cationically polymerizable cyclic siloxane can be applied as a single layer coating, has sufficient adherence to a cycloolefin-based copolymer substrate, and is excellent in moisture resistance. The present disclosure was completed based on these findings.

That is, the present disclosure provides a curable resin composition for coating a cycloolefin-based copolymer substrate, the curable resin composition containing an alicyclic ketone compound and/or an alicyclic ether compound, and a cationically polymerizable silsesquioxane and/or a cationically polymerizable cyclic siloxane.

The curable resin composition preferably has a viscosity of 15 mPa·s or less at 25° C. When the viscosity is within the above range, uniformity in film thickness is easily exhibited.

In the curable resin composition, the alicyclic ketone compound is preferably cyclohexanone or cyclopentanone, and the alicyclic ether compound is preferably cyclopentyl methyl ether.

In the curable resin composition, a cationically polymerizable functional group of the cationically polymerizable silsesquioxane preferably has a cyclic ether structure.

The present disclosure also provides a coating layer including a cured product of the curable resin composition.

Further, the present disclosure provides a laminate including the coating layer laminated on at least one cycloolefin-based copolymer substrate.

In the laminate, when 100 squares are formed on the coating layer in a lattice shape at 1 mm intervals, an adhesive tape is affixed thereto, and the adhesive tape is peeled off in a direction of 90°, preferably 90 or more squares remain. By having the above configurations, the curable resin composition can easily exhibit adherence.

In the laminate, an arithmetic mean height (Sa) of the coating layer is preferably 30 μm or less.

In the laminate, the cycloolefin-based copolymer substrate is preferably a substrate for a lens.

The present disclosure also provides a plastic lens provided with the laminate described above.

The present disclosure also provides an image display device provided with the laminate described above.

### Advantageous Effects of Invention

The curable resin composition of the present disclosure can be applied in a single layer coating, has sufficient adherence to a cycloolefin-based copolymer substrate, and is excellent in moisture resistance. Therefore, the curable resin composition can be suitably used as a coating of a cycloolefin-based copolymer substrate.

### DESCRIPTION OF EMBODIMENTS

### Curable Resin Composition

The curable resin composition according to an embodiment of the present disclosure is a curable resin composition for coating a cycloolefin-based copolymer substrate, and includes an alicyclic ketone compound and/or an alicyclic ether compound, and a cationically polymerizable silsesquioxane and/or a cationically polymerizable cyclic siloxane. By containing the alicyclic ketone compound or the alicyclic ether compound, the curable resin composition can suitably penetrate into the surface of the cycloolefin-based copolymer substrate, and when the curable resin composition is cured, the resulting cured resin composition is firmly adhered even when only a single layer. In addition, when the curable resin composition contains the cationically polymerizable silsesquioxane and/or the cationically polymerizable cyclic siloxane and is applied as a coating layer, sufficient surface hardness and moisture resistance can be exhibited.

Cationically Polymerizable Silsesquioxane and/or Cationically Polymerizable Cyclic Siloxane

The curable resin composition contains a cationically polymerizable silsesquioxane and/or a cationically polymerizable cyclic siloxane. A single type of either of the cationically polymerizable silsesquioxane or the cationically polymerizable cyclic siloxane may be used alone, or two or more types of either may be used in combination. A single type of each of the cationically polymerizable silsesquioxane and the cationically polymerizable cyclic siloxane may be used, or two or more types of each may be used in combination.

The cationically polymerizable silsesquioxane is a compound having a cationically polymerizable functional group in the molecule. Examples of the “cationically polymerizable functional group” include an epoxy group, an oxetane group, a vinyl ether group, and a vinyl phenyl group. Among these, from the viewpoints of further increasing the surface hardness of the coating layer and exhibiting moisture resistance, the cationically polymerizable functional group is preferably a group having a cyclic ether structure, and is particularly preferably an epoxy group.

The group containing an epoxy group is not particularly limited, and examples thereof include well-known or commonly-used groups having an oxirane ring. However, in terms of curability of the curable resin composition and heat resistance of the coating layer, a group represented by Formula (1a) below, a group represented by Formula (1b) below, a group represented by Formula (1c) below, and a group represented by Formula (1d) below are preferred, a group represented by Formula (1a) below and a group represented by Formula (1c) below are more preferred, and a group represented by Formula (1a) below is even more preferred.

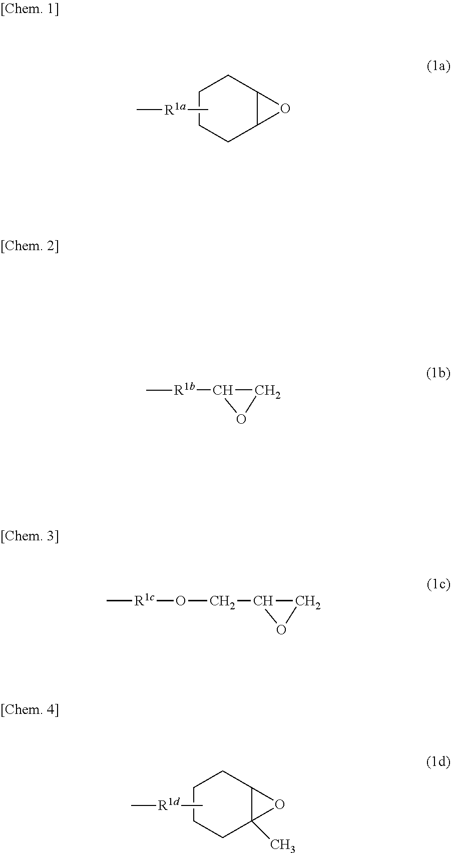

In Formula (1a) above, R^{1a} represents a linear or branched alkylene group. Examples of the linear or branched alkylene group include linear or branched alkylene groups having from 1 to 10 carbons, such as a methylene group, a methyl methylene group, a dimethyl methylene group, an ethylene group, a propylene group, a trimethylene group, a tetramethylene group, a pentamethylene group, a hexamethylene group, and a decamethylene group. Among these, from the viewpoint of the curability of the curable resin composition, R^{1a} is preferably a linear alkylene group having from 1 to 4 carbons or a branched alkylene group having 3 or 4 carbons, more preferably an ethylene group, a trimethylene group, or a propylene group, even more preferably an ethylene group or a trimethylene group.

In Formula (1b) above, R^{1b} represents a linear or branched alkylene group, and examples thereof include the same groups listed as examples of Ria. Among these, from the viewpoint of the curability of the curable resin composition, R^{1b} is preferably a linear alkylene group having from 1 to 4 carbons or a branched alkylene group having 3 or 4 carbons, more preferably an ethylene group, a trimethylene group, or a propylene group, and even more preferably an ethylene group or a trimethylene group.

In Formula (1c) above, R^{1c} represents a linear or branched alkylene group, and examples thereof include the same groups listed as examples of Ria. Among these, from the viewpoint of the curability of the curable resin composition, R^{1c} is preferably a linear alkylene group having from 1 to 4 carbons or a branched alkylene group having 3 or 4 carbons, more preferably an ethylene group, a trimethylene group, or a propylene group, and even more preferably an ethylene group or a trimethylene group.

In Formula (1d) above, R^{1d} represents a linear or branched alkylene group, and examples thereof include the same groups listed as examples of R^{1a}. Among these, from the viewpoint of the curability of the curable resin composition, R^{1d} is preferably a linear alkylene group having from 1 to 4 carbons or a branched alkylene group having 3 or 4 carbons, more preferably an ethylene group, a trimethylene group, or a propylene group, and even more preferably an ethylene group or a trimethylene group.

As the group containing an epoxy group, a group represented by Formula (1a) above in which R^{1a} is an ethylene group (especially, a 2-(3,4-epoxycyclohexyl)ethyl group) is preferable.

Examples of the cationically polymerizable silsesquioxane include compounds having a constituent unit represented by Formula (1) below.

[R¹SiO_{3/2}] (1)

The constituent unit represented by Formula (1) above is a silsesquioxane constituent unit (so-called T unit) generally represented by [RSiO_{3/2}]. Here, R in the formula described above represents a hydrogen atom or a monovalent organic group, and the same shall apply hereafter. The constituent unit represented by Formula (1) above is formed by a hydrolysis and condensation reaction of a corresponding hydrolyzable trifunctional silane compound. Note that in the present specification, a compound having a constituent unit represented by the above Formula (1) may be referred to as a “silsesquioxane (X)”. R¹ in Formula (1) represents a group (monovalent group) containing the above-described cationically polymerizable functional group.

The silsesquioxane (X) may include only one type of constituent unit represented by Formula (1) above or may include two or more types of constituent units represented by Formula (1) above.

The silsesquioxane (X) may also include, as the silsesquioxane constituent unit [RSiO_{3/2}], a constituent unit represented by Formula (2) below, in addition to the constituent unit represented by Formula (1) above.

[R²SiO_{3/2}] (2)

The constituent unit represented by Formula (2) above is a silsesquioxane constituent unit (T unit) generally represented by [RSiO_{3/2}]. That is, the constituent unit represented by Formula (2) above is formed by a hydrolysis and condensation reaction of a corresponding hydrolyzable trifunctional silane compound.

R² in Formula (2) represents a substituted or unsubstituted aryl group, a substituted or unsubstituted aralkyl group, a substituted or unsubstituted cycloalkyl group, or a substituted or unsubstituted alkyl group. Examples of the aryl group include a phenyl group, a tolyl group, and a naphthyl group. Examples of the aralkyl group include a benzyl group and a phenethyl group. Examples of the cycloalkyl group include a cyclobutyl group, a cyclopentyl group, and a cyclohexyl group. Examples of the alkyl group include linear or branched alkyl groups, such as a methyl group, an ethyl group, a propyl group, an n-butyl group, an isopropyl group, an isobutyl group, an s-butyl group, a t-butyl group, and an isopentyl group.

Examples of the substituted aryl group, the substituted aralkyl group, the substituted cycloalkyl group, and the substituted alkyl group described above include groups in which some or all of hydrogen atoms or the main chain skeleton in each of the aryl groups, the aralkyl groups, the cycloalkyl groups, and the alkyl groups described above are substituted with at least one selected from the group consisting of an alkyl group (in particular, a linear or branched alkyl group having from 1 to 10 carbons), an ether group, an ester group, a carbonyl group, a siloxane group, a halogen atom (such as a fluorine atom), a mercapto group, an amino group, and a hydroxy (hydroxyl) group.

Among these, R² is preferably a substituted or unsubstituted aryl group or a substituted or unsubstituted alkyl group, more preferably a substituted or unsubstituted aryl group, and even more preferably a phenyl group.

A ratio of each above-described silsesquioxane constituent unit (the constituent unit represented by Formula (1) and the constituent unit represented by Formula (2)) in the silsesquioxane (X) can be appropriately adjusted by the composition of the raw materials (hydrolyzable trifunctional silanes) for forming these constituent units.

Among these constituent units, the silsesquioxane (X) preferably contains at least a constituent unit represented by the above Formula (1) in which R¹ is a group containing an alicyclic epoxy group and a constituent unit represented by the above Formula (2) in which R² is an aryl group which may have a substituent. In this case, the surface hardness, flexibility, workability, and flame retardancy of the coating layer tend to be more excellent.

In addition to the constituent unit represented by Formula (1) above and the constituent unit represented by Formula (2) above, which are T units, the silsesquioxane (X) may further contain at least one siloxane constituent unit selected from the group consisting of a constituent unit represented by [R₃SiO_{1/2}](so-called M unit), a constituent unit represented by [R₂SiO_{2/2}](so-called D unit), and a constituent unit represented by [SiO_{4/2}](so-called Q unit). Note that examples of R in the M unit and the D unit include the same groups as those exemplified as R¹ in the constituent unit represented by Formula (1) and those exemplified as R² in the constituent unit represented by Formula (2). An example of a silsesquioxane constituent unit other than the constituent unit represented by Formula (1) above and the constituent unit represented by Formula (2) above include a constituent unit represented by Formula (3) below.

[HSiO_{3/2}] (3)

The silsesquioxane (X) includes a constituent unit (T3 form) represented by Formula (I) below. The silsesquioxane (X) may further include a constituent unit (T2 form) represented by Formula (II) below.

[R^{a}SiO_{3/2}] (I)

[R^{b}SiO_{2/2}(OR^{c})] (II)

The constituent unit represented by Formula (I) above is represented by Formula (I′) below in more detail. Furthermore, the constituent unit represented by Formula (II) above is represented by Formula (II′) below in more detail. Three oxygen atoms bonded to the silicon atom illustrated in the structure represented by formula (I′) below are each bonded to another silicon atom (a silicon atom not illustrated in formula (I′)). On the other hand, two oxygen atoms located above and below the silicon atom illustrated in the structure represented by Formula (II′) below are each bonded to another silicon atom (a silicon atom not illustrated in Formula (II′)). That is, both T3 form and T2 form are constituent units (T units) formed by a hydrolysis and condensation reaction of a corresponding hydrolyzable trifunctional silane compound.

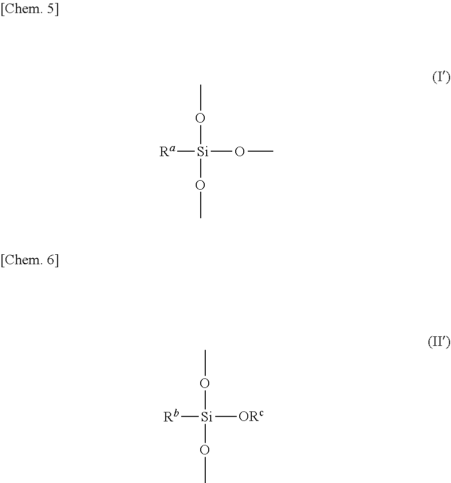

R^{a} in Formula (I) above (likewise, R^{a} in Formula (I′)) and R^{b} in Formula (II) above (likewise, R^{b} in Formula (II′)) each represent a group containing a cationically polymerizable functional group, a substituted or unsubstituted aryl group, a substituted or unsubstituted aralkyl group, a substituted or unsubstituted cycloalkyl group, a substituted or unsubstituted alkyl group, or a hydrogen atom. Specific examples of R^{a} and R^{b} include the same examples as those given for R¹ in Formula (1) above and R² in Formula (2) above. R^{a} in Formula (I) and R^{b} in Formula (II) are each a group derived from a group (a group other than an alkoxy group and a halogen atom) bonded to a silicon atom in the hydrolyzable trifunctional silane compound used as a raw material of the silsesquioxane (X), or, in a case in which the cationically polymerizable functional group is an epoxy group, a group produced by epoxidizing a group (a group other than an alkoxy group and a halogen atom) bonded to a silicon atom in the hydrolyzable trifunctional silane compound used as a raw material of the silsesquioxane (X).

R^{c} in Formula (II) above (likewise, R^{c} in Formula (II′)) represents a hydrogen atom or an alkyl group having from 1 to 4 carbons. Examples of the alkyl group having from 1 to 4 carbons include a linear or branched alkyl group having from 1 to 4 carbons, such as a methyl group, an ethyl group, a propyl group, an isopropyl group, a butyl group, and an isobutyl group. Among these, a methyl group and an ethyl are preferable, and a methyl group is more preferable. The alkyl group of R^{c} in Formula (II) is typically derived from an alkyl group that forms an alkoxy group in a hydrolyzable silane compound used as a raw material for the silsesquioxane (X).

In the silsesquioxane (X), a molar ratio of the constituent units represented by Formula (I) above (T3 forms) to the constituent units represented by Formula (II) above (T2 forms), [constituent units represented by Formula (I)/constituent units represented by Formula (II)](may be described as “T3 form/T2 form”), is not particularly limited, but is preferably 5 or greater, more preferably from 5 to 20, even more preferably from 5 to 18, yet even more preferably from 6 to 16, still more preferably from 7 to 15, and particularly preferably from 8 to 14. When the above [(T3 form)/(T2 form)] molar ratio is 5 or greater, the surface hardness of the coating layer tends to further improve.

The above molar ratio [T3 form/T2 form] in the silsesquioxane (X) can be determined, for example, through ²⁹Si-NMR spectrum measurements. In the ²⁹Si-NMR spectrum, the silicon atoms in the constituent units represented by Formula (I) above (T3 forms) and the silicon atoms in the constituent units represented by Formula (II) above (T2 forms) exhibit signals (peaks) at different positions (chemical shifts), and thus the above-mentioned [T3 form/T2 form] molar ratio can be determined by calculating the integration ratio of these peaks. Specifically, for example, when the silsesquioxane (X) includes a constituent unit represented by Formula (1) above in which R¹ is a 2-(3,4-epoxycyclohexyl)ethyl group, the signal of the silicon atom in the structure (T3 form) represented by Formula (I) above appears in a range from −64 to −70 ppm, and the signal of the silicon atom in the structure (T2 form) represented by Formula (II) above appears in a range from −54 to −60 ppm. Thus, in this case, the above molar ratio [T3 form/T2 form] can be determined by calculating the integration ratio of the signal (T3 form) in the range from −64 to −70 ppm and the signal (T2 form) in the range from −54 to −60 ppm.

The ²⁹Si-NMR spectrum of the silsesquioxane (X) can be measured, for example, with the following instrument and under the following conditions.
Measuring instrument: “JNM-ECA500NMR” (trade name, available from JEOL Ltd.)
Solvent: deuterochloroform
Cumulative number of times: 1800
Measurement temperature: 25° C.

When the above molar ratio [T3 form/T2 form] of the silsesquioxane (X) is 5 or greater, this means that a certain amount or more of the T2 forms are present relative to the T3 forms in the silsesquioxane (X). Examples of the T2 form include a constituent unit represented by Formula (4) below, a constituent unit represented by Formula (5) below, and a constituent unit represented by Formula (6) below. R¹ in Formula (4) below and R² in Formula (5) below are the same as the R¹ in Formula (1) above and the R² in Formula (2) above, respectively. R^{c} in Formulae (4) to (6) below represents a hydrogen atom or an alkyl group having from 1 to 4 carbons, in the same manner as R^{c} in Formula (II).

[R¹SiO_{2/2}(OR^{c})] (5)

[R²SiO_{2/2}(OR^{c})] (5)

[HSiO_{2/2}(OR^{c})] (6)

The cationically polymerizable silsesquioxane (in particular, the silsesquioxane (X)) may be a silsesquioxane having a cage shape (cage-type silsesquioxane). Examples of the cage-type silsesquioxane include a complete cage-type silsesquioxane and an incomplete cage-type silsesquioxane, and among these, an incomplete cage-type silsesquioxane is preferable.

Typically, a complete cage-type silsesquioxane is a polyorganosilsesquioxane constituted of a T3 form only, and no T2 form is present in the molecule. That is, a silsesquioxane having the above molar ratio [T3 form/T2 form] of 5 or greater and having one inherent absorption peak near 1100 cm⁻¹ in an FT-IR spectrum as described later suggests the inclusion of an incomplete cage-type silsesquioxane structure.

Whether the silsesquioxane (X) has a cage-type (incomplete cage-type) silsesquioxane structure can be confirmed by the FT-IR spectrum [refer to R. H. Raney, M. Itoh, A. Sakakibara and T. Suzuki, Chem. Rev. 95, 1409 (1995)]. Specifically, if the silsesquioxane (X) has one inherent absorption peak near 1100 cm⁻¹ without having inherent absorption peaks near 1050 cm⁻¹ and 1150 cm⁻¹ in the FT-IR spectrum, the silsesquioxane (X) can be identified as having a cage-type (incomplete cage-type) silsesquioxane structure. In contrast, a silsesquioxane (X) having inherent absorption peaks near 1050 cm⁻¹ and near 1150 cm⁻¹ each in the FT-IR spectrum is typically identified as having a ladder-type silsesquioxane structure. The FT-IR spectrum of the silsesquioxane (X) can be measured, for example, with the following instrument and conditions.
Measuring instrument: trade name “FT-720” (available from Horiba, Ltd.)
Measurement method: transmission method
Resolution: 4 cm-1
Measurement wavenumber range: from 400 to 4000 cm-1
Cumulative number of times: 16

The proportion (total amount) of the constituent unit having the cationically polymerizable functional group (for example, the constituent unit represented by Formula (1) above, the constituent unit represented by Formula (4) above, and the like) relative to a total amount (100 mol %) of siloxane constituent units [all siloxane constituent units; total amount of M units, D units, T units, and Q units] in the cationically polymerizable silsesquioxane is not particularly limited, but is preferably 50 mol % or greater (for example, from 50 to 100 mol %), more preferably from 55 to 100 mol %, even more preferably from 65 to 99.9 mol %, yet even more preferably from 80 to 99 mol %, and particularly preferably from 90 to 98 mol %. When the above proportion is 50 mol % or greater, the curability of the curable resin composition improves, and the surface hardness of the coating layer significantly increases. In addition, the proportion of each siloxane constituent unit in the cationically polymerizable silsesquioxane can be calculated, for example, from the raw material composition, through NMR spectrum measurements, or the like.

The proportion of the constituent unit (T3 form) represented by Formula (I) above relative to the total amount (100 mol %) of siloxane constituent units [all siloxane constituent units; total amount of M units, D units, T units, and Q units] in the silsesquioxane (X) is not particularly limited, but is preferably 50 mol % or greater, more preferably from 60 to 99 mol %, even more preferably from 70 to 98 mol %, yet even more preferably from 80 to 95 mol %, and particularly preferably from 85 to 92 mol %. When the proportion of the constituent unit of the T3 form is 50 mol % or greater, the surface hardness of the coating layer tends to further improve. This is presumed to be due to a facilitation of the formation of an incomplete cage shape having an appropriate molecular weight.

The proportion (total amount) of the constituent unit represented by Formula (2) above and the constituent unit represented by Formula (5) above relative to the total amount (100 mol %) of siloxane constituent units [all siloxane constituent units; total amount of M units, D units, T units, and Q units] in the silsesquioxane (X) is not particularly limited, but is preferably from 0 to 50 mol %, more preferably from 0 to 40 mol %, even more preferably from 0 to 30 mol %, and particularly preferably from 1 to 15 mol %. When the above proportion is 50 mol % or less, the proportion of the constituent unit having a cationically polymerizable functional group can be relatively increased, and thus such a proportion tends to improve the curability of the curable resin composition and further increase the surface hardness of the coating layer.

The proportion (total amount) of the constituent unit represented by Formula (I) above and the constituent unit represented by Formula (II) above (in particular, the proportion of the total of T3 forms and T2 forms) relative to the total amount (100 mol %) of siloxane constituent units [all siloxane constituent units; total amount of M units, D units, T units, and Q units] in the silsesquioxane (X) is not particularly limited, but is preferably 60 mol % or greater (for example, from 60 to 100 mol %), more preferably from 70 mol % or greater, even more preferably from 80 mol % or greater, and particularly preferably from 90 mol % or greater. When the above proportion is 60 mol % or greater, the surface hardness of the coating layer tends to further improve. This is presumed to be due to a facilitation of the formation of an incomplete cage shape having an appropriate molecular weight. In particular, the proportion (total amount) of the constituent unit represented by the Formula (1) above, the constituent unit represented by the Formula (2) above, the constituent unit represented by the Formula (4) above, and the constituent unit represented by the Formula (5) above is preferably within the above range.

The number average molecular weight (Mn) of the silsesquioxane (X) determined by gel permeation chromatography calibrated with standard polystyrene is not particularly limited, but is preferably from 1000 to 3000, more preferably from 1000 to 2800, even more preferably from 1100 to 2600, and particularly preferably from 1500 to 2500. When the number average molecular weight is 1000 or greater, the surface hardness of the coating layer tends to further improve. The heat resistance and abrasion resistance of the coating layer also tend to improve. On the other hand, when the number average molecular weight is 3000 or less, the compatibility with other components in the curable resin composition and the heat resistance of the coating layer tend to improve.

The molecular weight dispersity (Mw/Mn) of the silsesquioxane (X) determined by gel permeation chromatography calibrated with standard polystyrene is not particularly limited, but is preferably from 1.0 to 3.0, more preferably from 1.1 to 2.0, even more preferably from 1.2 to 1.9, yet even more preferably from 1.3 to 1.8, and particularly preferably from 1.45 to 1.80. When the molecular weight dispersity is 3.0 or less, the surface hardness of the coating layer tends to further increase. On the other hand, when the molecular weight dispersity is 1.0 or greater (in particular, 1.1 or greater), the silsesquioxane (X) tends to easily become a liquid, and handling ease tends to improve.

The number average molecular weight and the molecular weight dispersity of the silsesquioxane (X) can be measured with the following instrument and conditions.
Measuring instrument: “LC-20AD” (trade name, available from Shimadzu Corporation)
Column: Shodex KF-801×quantity of 2, KF-802, and KF-803 (available from Showa Denko K.K.)
Measurement temperature: 40° C.
Eluent: THF, sample concentration of from 0.1 to 0.2 mass %
Flow rate: 1 mL/min
Detector: UV-VIS detector (“SPD-20A” (trade name) available from Shimadzu Corporation)
Molecular weight: calibrated with standard polystyrene

The method for producing the cationically polymerizable silsesquioxane is not particularly limited, and the cationically polymerizable silsesquioxane can be produced by a well-known or commonly used silsesquioxane production method. Examples include a method of subjecting one or more types of hydrolyzable silane compounds to hydrolysis and condensation.

The cationically polymerizable cyclic siloxane is a compound having at least a cyclic siloxane skeleton configured of a siloxane bond (Si—O—Si). In addition to the cyclic siloxane skeleton, the cationically polymerizable cyclic siloxane may include a siloxane skeleton such as a linear or branched silicone (linear or branched polysiloxane) or a cage-type or ladder-type polysilsesquioxane.

The number of Si—O units (equal to the number of silicon atoms forming the siloxane ring) forming a siloxane ring in the cationically polymerizable cyclic siloxane is preferably from 2 to 12, and more preferably from 4 to 8.

The cationically polymerizable cyclic siloxane preferably has two or more alicyclic epoxy groups per molecule. The term “alicyclic epoxy group” means a cyclic olefin group epoxidized in the molecule. The “cyclic olefin group epoxidized” is a group (monovalent group) formed by removing one hydrogen atom from a structure in which at least one carbon-carbon unsaturated bond of a cyclic olefin (a cyclic aliphatic hydrocarbon in which at least one of the carbon-carbon bonds forming a ring is a carbon-carbon unsaturated bond) is epoxidized. That is, the epoxidized cyclic olefin group is a group that includes an aliphatic hydrocarbon ring structure and an epoxy group, with the epoxy group being configured by two adjacent carbon atoms and an oxygen atom, which together configure the aliphatic hydrocarbon ring.

Examples of the cyclic olefin group (the form before epoxidation) in the epoxidized cyclic olefin group include a cycloalkenyl group such as a cyclopropenyl group (e.g., a 2-cyclopropen-1-yl group), a cyclobutenyl group (e.g., a 2-cyclobuten-1-yl group), a cyclopentenyl group (e.g., a 2-cyclopenten-1-yl group, a 3-cyclopenten-1-yl group), and a cyclohexenyl group (e.g., a 2-cyclohexen-1-yl group, a 3-cyclohexen-1-yl group); a cycloalkadienyl group such as a 2,4-cyclopentadien-1-yl group, a 2,4-cyclohexadien-1-yl group, and a 2,5-cyclohexadien-1-yl group; and a polycyclic group such as a dicyclopentenyl group, a dicyclohexenyl group, and a norbornenyl group.

Note that one or more substituents may be bonded to the aliphatic hydrocarbon ring forming the cyclic olefin group in the epoxidized cyclic olefin group. Examples of the substituent include substituents having from 0 to 20 carbons (more preferably 0 to 10 carbon atoms), and more specific examples thereof include halogen atoms such as a fluorine atom, a chlorine atom, a bromine atom, and an iodine atom; a hydroxy group; alkoxy groups (preferably a C₁₋₆ alkoxy group, more preferably a C₁₋₄ alkoxy group) such as a methoxy group, an ethoxy group, a propoxy group, an isopropyloxy group, a butoxy group, and an isobutyloxy group; an alkenyloxy group (preferably a C₂₋₆ alkenyloxy group, more preferably a C₂₋₄ alkenyloxy group) such as an allyloxy group; an aryloxy group (preferably a C₆₋₁₄ aryloxy group) which may have a substituent such as C₁₋₄ alkyl group, a C₂₋₄ alkenyl group, a halogen atom, or a C₁₋₄ alkoxy group on the aromatic ring, such as a phenoxy group, a tolyloxy group, and a naphthyloxy group; an aralkyloxy group (preferably a C₇₋₁₈ aralkyloxy group) such as a benzyloxy group and a phenethyloxy group; an acyloxy group (preferably a C₁₋₁₂ acyloxy group) such as an acetyloxy group, a propionyloxy group, a (meth)acryloyloxy group, and a benzoyloxy group; a mercapto group; an alkylthio group (preferably a C₁₋₆ alkylthio group, more preferably a C₁₋₄ alkylthio group) such as a methylthio group and an ethylthio group; an alkenylthio group (preferably a C₂₋₆ alkenylthio group, more preferably a C₂₋₄ alkenylthio group) such as an allylthio group; an arylthio group (preferably a C₆₋₁₄ arylthio group) which may have a substituent such as C₁₋₄ alkyl group, a C₂₋₄ alkenyl group, a halogen atom, or a C₁₋₄ alkoxy group on the aromatic ring, such as a phenylthio group, a tolylthio group, and a naphthylthio group; an aralkylthio group (preferably a C₇₋₁₈ aralkylthio group) such as a benzylthio group and a phenethylthio group; a carboxy group; an alkoxycarbonyl group (preferably a C₁₋₆ alkoxycarbonyl group) such as a methoxycarbonyl group, an ethoxycarbonyl group, a propoxycarbonyl group, and a butoxycarbonyl group; an aryloxycarbonyl group (preferably C₆₋₁₄ aryloxycarbonyl group) such as a phenoxycarbonyl group, a tolyloxycarbonyl group, and a naphthyloxycarbonyl group; an aralkyloxycarbonyl group (preferably a C₇₋₁₈ aralkyloxy-carbonyl group) such as a benzyloxycarbonyl group; an amino group; a mono- or dialkylamino group (preferably a mono- or di-C₁₋₆ alkylamino group) such as a methylamino group, an ethylamino group, a dimethylamino group, and a diethylamino group; an acylamino group (preferably a C₁₋₁₁ acylamino group) such as an acetylamino group, a propionylamino group, and a benzoylamino group; an oxetanyl group-containing group such as an ethyl oxetanyloxy group; an acyl group such as an acetyl group, a propionyl group, and a benzoyl group; an oxo group; and groups produced by optionally bonding two or more of these groups through a C₁₋₆ alkylene group.

Among these, the cyclic olefin group is preferably a cyclic olefin group having from 5 to 12 carbons, more preferably a cycloalkenyl group having from 5 to 12 carbons, and still more preferably a cyclohexenyl group. That is, the epoxidized cyclic olefin group is preferably a group produced by epoxidizing a cyclic olefin group having from 5 to 12 carbons, more preferably a group produced by epoxidizing a cycloalkenyl group having from 5 to 12 carbons, and still more preferably a group (a cyclohexene oxide group) produced by epoxidizing a cyclohexenyl group. The first epoxy compound may have one type of epoxidized cyclic olefin group or may have two or more types of epoxidized cyclic olefin groups.

The number of epoxidized cyclic olefin groups per molecule of the first epoxy compound may be 2 or greater, and is not particularly limited, but is preferably from 2 to 6, more preferably from 3 to 5, and even more preferably 4.

Examples of the cationically polymerizable cyclic siloxane include 2,4-di[2-(3-{oxabicyclo[4.1.0]heptyl})ethyl]-2,4,6,6,8,8-hexamethyl-cyclotetrasiloxane, 4,8-di[2-(3-{oxabicyclo[4.1.0]heptyl})ethyl]-2,2,4,6,6,8-hexamethyl-cyclotetrasiloxane, 2,4-di[2-(3-{oxabicyclo[4.1.0]heptyl})ethyl]-6,8-dipropyl-2,4,6,8-tetramethyl-cyclotetrasiloxane, 4,8-di[2-(3-{oxabicyclo[4.1.0]heptyl})ethyl]-2,6-dipropyl-2,4,6,8-tetramethyl-cyclotetrasiloxane, 2,4,8-tri[2-(3-{oxabicyclo[4.1.0]heptyl})ethyl]-2,4,6,6,8-pentamethyl-cyclotetrasiloxane, 2,4,8-tri[2-(3-{oxabicyclo[4.1.0]heptyl})ethyl]-6-propyl-2,4,6,8-tetramethyl-cyclotetrasiloxane, and 2,4,6,8-tetra[2-(3-{oxabicyclo[4.1.0]heptyl})ethyl]-2,4,6,8-tetramethyl-cyclotetrasiloxane.

The content of the cationically polymerizable silsesquioxane and the cationically polymerizable cyclic siloxane in the curable resin composition is not particularly limited, but is preferably greater than 50 mass % (for example, greater than 50 mass % and less than or equal to 99 mass %), more preferably from 60 to 96 mass %, even more preferably from 70 to 95 mass %, and particularly preferably from 80 to 93 mass %, relative to the total amount (100 mass %) of the curable compounds. When the content proportion thereof is greater than 50 mass %, the surface hardness of the coating layer tends to further improve and moisture resistance tends to be exhibited. When the above content proportion is 99 mass % or less, the curable resin composition can contain other components, and the effects achieved by containing these components tend to further improve. Moreover, the curable resin composition can contain a curing catalyst, and thereby curing of the curable resin composition tends to proceed more efficiently. In a case in which the curable resin composition contains either the cationically polymerizable silsesquioxane or the cationically polymerizable cyclic siloxane, the content thereof preferably satisfies the above range.

In addition, relative to the total amount (100 mass %) of the curable resin composition, the content of the cationically polymerizable silsesquioxane and the cationically polymerizable cyclic siloxane is preferably from 10 to 90 mass %, more preferably from 12 to 80 mass %, and still more preferably from 14 to 70 mass %. When the above content is 10 mass % or greater, the curable resin composition can be easily used as a coating layer when cured. When the above content is 90 mass % or less, the curable resin composition can sufficiently contain an alicyclic ketone compound and/or an alicyclic ether compound, and adherence to a cycloolefin-based copolymer substrate can be exhibited. In a case in which the curable resin composition contains either the cationically polymerizable silsesquioxane or the cationically polymerizable cyclic siloxane, the content thereof preferably satisfies the above range.

Alicyclic Ketone Compound and/or Alicyclic Ether Compound

The curable resin composition contains an alicyclic ketone compound and/or an alicyclic ether compound. The alicyclic ketone compound and the alicyclic ether compound are preferably liquids at room temperature (about 25° C.), and are used as solvents in the curable resin composition. When the curable resin composition contains the alicyclic ketone compound or the alicyclic ether compound, the curable resin composition can appropriately penetrate into the surface of the cycloolefin-based copolymer substrate, and can exhibit sufficient adherence even as a single layer. As the alicyclic ketone compound and/or the alicyclic ether compound, a single type of either one may be used alone, or two or more types of either one may be used in combination. Moreover, a single type of each of the alicyclic ketone compound and the alicyclic ether compound may be used alone, or two or more types of each may be used in combination.

The alicyclic ketone compound is a compound having at least an alicyclic ring and a ketone group in the structure, and need not have a ketone group on the alicyclic ring, but is preferably a compound having a ketone group on the alicyclic ring. The alicyclic ring is preferably a cyclic aliphatic hydrocarbon that does not contain a carbon-carbon unsaturated bond, and the alicyclic ring may be monocyclic or polycyclic. Specific examples of the monocyclic ring include a cycloalkyl group having from 3 to 10 carbons, and preferably a cycloalkyl group having from 4 to 7 carbons. Examples of the polycyclic ring include 5- to 7-membered polycyclic aliphatic hydrocarbons not having a carbon-carbon unsaturated bond, and the number of rings of the polycyclic ring is preferably from 2 to 10.

Furthermore, one or more substituents besides a ketone group may be bonded to the alicyclic ring. Examples of the substituent include substituents having from 0 to 20 carbons, and more specific examples thereof include a halogen atom such as a fluorine atom, a chlorine atom, a bromine atom, and an iodine atom; a hydroxy group; an alkoxy group (preferably a C₁₋₆ alkoxy group) such as a methoxy group, an ethoxy group, a propoxy group, an isopropyloxy group, a butoxy group, and an isobutyloxy group; an alkenyloxy group (preferably a C₂₋₆ alkenyloxy group) such as an allyloxy group; an aryloxy group (preferably a C₆₋₁₄ aryloxy group) which may have a substituent such as C₁₋₄ alkyl group, a C₂₋₄ alkenyl group, a halogen atom, or a C₁₋₄ alkoxy group on the aromatic ring, such as a phenoxy group, a tolyloxy group, and a naphthyloxy group; an aralkyloxy group (preferably a C₇₋₁₈ aralkyloxy group) such as a benzyloxy group and a phenethyloxy group; an acyloxy group (preferably a C₁₋₁₂ acyloxy group) such as an acetyloxy group, a propionyloxy group, a (meth)acryloyloxy group, and a benzoyloxy group; a mercapto group; an alkylthio group (preferably a C₁₋₆ alkylthio group, more preferably a C₁₋₄ alkylthio group) such as a methylthio group and an ethylthio group; an alkenylthio group (preferably a C₂₋₆ alkenylthio group, more preferably C₂₋₄ alkenylthio group) such as an allylthio group; an arylthio group (preferably a C₆₋₁₄ arylthio group) which may have a substituent such as C₁₋₄ alkyl group, a C₂₋₄ alkenyl group, a halogen atom, or a C₁₋₄ alkoxy group on the aromatic ring, such as a phenylthio group, a tolylthio group, and a naphthylthio group; an aralkylthio group (preferably a C₇₋₁₈ aralkylthio group) such as a benzylthio group and a phenethylthio group; a carboxy group; an alkoxycarbonyl group (preferably a C₁₋₆ alkoxycarbonyl group) such as a methoxycarbonyl group, an ethoxycarbonyl group, a propoxycarbonyl group, and a butoxycarbonyl group; an aryloxycarbonyl group (preferably C₆₋₁₄ aryloxycarbonyl group) such as a phenoxycarbonyl group, a tolyloxycarbonyl group, and a naphthyloxycarbonyl group; an aralkyloxycarbonyl group (preferably a C₇₋₁₈ aralkyloxy-carbonyl group) such as a benzyloxycarbonyl group; an amino group; a mono- or dialkylamino group (preferably a mono- or di-C₁₋₆ alkylamino group) such as a methylamino group, an ethylamino group, a dimethylamino group, and a diethylamino group; an acylamino group (preferably a C₁₋₁₁ acylamino group) such as an acetylamino group, a propionylamino group, and a benzoylamino group; an oxetanyl group-containing group such as an ethyl oxetanyloxy group; an acyl group such as an acetyl group, a propionyl group, and a benzoyl group; an oxo group; and groups produced by optionally bonding two or more of these groups through a C₁₋₆ alkylene group.

Among these, the alicyclic ketone compound is preferably a compound having a monocyclic ring as an alicyclic ring, and specific examples thereof include cyclopentanone, cyclohexanone, cycloheptanone, and 2-methyl-cyclopentanone. Furthermore, from the viewpoint of the action on the cycloolefin-based copolymer substrate, the alicyclic ketone compound is more preferably cyclohexanone or cyclopentanone.

The alicyclic ether compound is a compound having at least an alicyclic ring and an ether group in the structure, preferably a compound in which a group having the alicyclic ring, and the group having the alicyclic ring or a hydrocarbon group other than the group having the alicyclic ring are linked via an ether group, and is more preferably a compound in which the group having the alicyclic ring and a hydrocarbon group other than the group having the alicyclic group are linked via an ether group. Specifically, the alicyclic ether compound is preferably a compound represented by the following Formula (A).

[Chem. 7]

R^{A}—O—R^{B} (A)

(In Formula (A), R^{A} represents a group having an alicyclic ring, and R^{B} represents an alkyl group having from 1 to 6 carbons.)

Examples of the alicyclic ring of the group having an alicyclic ring include the same alicyclic rings as those exemplified with regard to the alicyclic ketone compound.

R^{B} is preferably an alkyl group having from 1 to 6 carbons, and is more preferably an alkyl group having from 1 to 3 carbons.

Specifically, the alicyclic ether compound is preferably a cycloalkyl C₁₋₆ alkyl ether, and as the cycloalkyl C₁₋₆ alkyl ether, a cyclopentyl C₁₋₃ alkyl ether and a cyclohexyl C₁₋₃ alkyl ether are preferable, and among these, cyclopentyl methyl ether is more preferable.

The total content of the alicyclic ketone compound and the alicyclic ether compound is preferably from 15 to 90 mass %, more preferably from 25 to 85 mass %, and still more preferably from 35 to 80 mass % per the total amount (100 mass %) of the curable resin composition. When the total content of the alicyclic ketone compound and the alicyclic ether compound is 15 mass % or greater, the viscosity of the curable resin composition can be sufficiently reduced, and the curable resin composition can be easily and uniformly formed into a thin film. When the total content thereof is 90 mass % or less, the effect as a coating layer can be exhibited. In a case where the curable resin composition contains either the alicyclic ketone compound or the alicyclic ether compound, the content thereof preferably satisfies the above range.

The curable resin composition may further contain another solvent besides the alicyclic ketone compound and the alicyclic ether compound. However, from the viewpoint of exhibiting adherence to a cycloolefin-based copolymer substrate, the curable resin composition preferably does not contain the other solvent. The other solvent is not particularly limited as long as the solvent can dissolve the above-described cationically polymerizable silsesquioxane and any other components added as necessary and does not inhibit polymerization. A single type of the other solvent may be used alone, or two or more types may be used in combination.

The other solvent that is used is preferably one that can impart fluidity suitable for applying the coating layer and that can be easily removed by heating at a temperature at which the progression of polymerization can be suppressed, and preferably, a solvent having a boiling point (at 1 ATM) of not higher than 170° C. is used (for example, an aromatic solvent such as toluene, xylene, and mesitylene; esters such as butyl acetate; ketones such as methyl isobutyl ketone; and ethers such as propylene glycol monomethyl ether and propylene glycol monomethyl ether acetate).

In a case in which the curable resin composition contains the other solvent, the content thereof is preferably 1 mass % or greater, more preferably 3 mass % or greater, and still more preferably 5 mass % or greater with respect to the total amount (100 mass %) of the curable resin composition. The upper limit is not particularly limited, but is preferably 30 mass % or less, more preferably 25 mass % or less, and even more preferably 20 mass % or less.

The content of the alicyclic ketone compound and the alicyclic ether compound is preferably 50 mass % or greater, more preferably 80 mass % or greater, and still more preferably 90 mass % or greater with respect to the total amount (100 mass %) of the solvent. When the content of the alicyclic ketone compound and the alicyclic ether compound in the solvent is 50 mass % or greater, adherence to the cycloolefin-based copolymer substrate is easily exhibited. Moreover, the upper limit is not particularly limited and may be 100 mass %.

The curable resin composition may contain another curable compound besides the cationically polymerizable silsesquioxane. Examples of the other curable compound include other cationically polymerizable compounds other than the cationically polymerizable silsesquioxane, and radically polymerizable compounds. A single type of the other curable compound may be used alone, or two or more types of the other curable compounds may be used in combination.

Examples of the other cationically polymerizable compound include a compound having one or more epoxy groups per molecule other than the cationically polymerizable silsesquioxane (such a compound may be referred to as an “other epoxy compound”), a compound having one or more oxetane groups per molecule (such a compound may be referred to as an “oxetane compound”), a compound having one or more vinyl ether groups per molecule (such a compound may be referred to as a “vinyl ether compound”), and a compound having two or more hydroxy groups per molecule (such a compound may be referred to as a “polyol compound”).

Examples of the other epoxy compound include a compound having one or more glycidyl ether groups per molecule. Examples of the compound having one or more glycidyl ether groups per molecule include an aromatic glycidyl ether-based epoxy compound such as a bisphenol A-type epoxy compound, a bisphenol F-type epoxy compound, a biphenol-type epoxy compound, a phenol novolac-type epoxy compound, a cresol novolac-type epoxy compound, a cresol novolac-type epoxy compound of bisphenol A, a naphthalene-type epoxy compound, and an epoxy compound produced from trisphenolmethane; a hydrogenated glycidyl ether-based epoxy compound; a glycidyl ester-based epoxy compound; and a glycidyl amine-based epoxy compound.

Examples of the hydrogenated glycidyl ether-based epoxy compound include a compound produced by hydrogenating a bisphenol A-type epoxy compound (hydrogenated bisphenol A-type epoxy compounds), such as 2,2-bis[4-(2,3-epoxypropoxy)cyclohexyl]propane, 2,2-bis[3,5-dimethyl-4-(2,3-epoxypropoxy)cyclohexyl]propane, and multimers thereof, a compound produced by hydrogenating a bisphenol F-type epoxy compound (a hydrogenated bisphenol F-type epoxy compound), such as bis[o,o-(2,3-epoxypropoxy)cyclohexyl]methane, bis[o,p-(2,3-epoxypropoxy)cyclohexyl]methane, bis[p,p-(2,3-epoxypropoxy)cyclohexyl]methane, bis[3,5-dimethyl-4-(2,3-epoxypropoxy)cyclohexyl]methane, and multimers thereof, a hydrogenated biphenol-type epoxy compound; a hydrogenated phenol novolac-type epoxy compound; a hydrogenated cresol novolac-type epoxy compound; a hydrogenated cresol novolac-type epoxy compound of bisphenol A; a hydrogenated naphthalene-type epoxy compound; and a hydrogenated epoxy compound of an epoxy compound produced from trisphenolmethane.

Examples of the oxetane compound include trimethylene oxide, 3,3-bis(vinyloxymethyl)oxetane, 3-ethyl-3-hydroxymethyloxetane, 3-ethyl-3-(2-ethylhexyloxymethyl)oxetane, 3-ethyl-3-(hydroxymethyl)oxetane, 3-ethyl-3-[(phenoxy)methyl]oxetane, 3-ethyl-3-(hexyloxymethyl)oxetane, 3-ethyl-3-(chloromethyl)oxetane, 3,3-bis(chloromethyl)oxetane, 1,4-bis[(3-ethyl-3-oxetanylmethoxy)methyl]benzene, bis{[1-ethyl(3-oxetanyl)]methyl}ether, 4,4′-bis[(3-ethyl-3-oxetanyl)methoxymethyl]bicyclohexyl, 1,4-bis[(3-ethyl-3-oxetanyl)methoxymethyl]cyclohexane, and 3-ethyl-3{[(3-ethyloxetan-3-yl)methoxy]methyl}oxetane.

Examples of the vinyl ether compound include 2-hydroxyethyl vinyl ether, 3-hydroxypropyl vinyl ether, 2-hydroxypropyl vinyl ether, 2-hydroxyisopropyl vinyl ether, 4-hydroxybutyl vinyl ether, 3-hydroxybutyl vinyl ether, 2-hydroxybutyl vinyl ether, 3-hydroxyisobutyl vinyl ether, 2-hydroxyisobutyl vinyl ether, 1-methyl-3-hydroxypropyl vinyl ether, 1-methyl-2-hydroxypropyl vinyl ether, 1-hydroxymethylpropyl vinyl ether, 4-hydroxycyclohexyl vinyl ether, 1,6-hexanediol monovinyl ether, 1,4-cyclohexane dimethanol monovinyl ether, 1,3-cyclohexane dimethanol monovinyl ether, 1,2-cyclohexane dimethanol monovinyl ether, p-xyleneglycol monovinyl ether, m-xyleneglycol monovinyl ether, o-xyleneglycol monovinyl ether, diethylene glycol monovinyl ether, triethylene glycol monovinyl ether, tetraethylene glycol monovinyl ether, pentaethylene glycol monovinyl ether, oligoethylene glycol monovinyl ether, polyethylene glycol monovinyl ether, dipropylene glycol monovinyl ether, tripropylene glycol monovinyl ether, tetrapropylene glycol monovinyl ether, pentapropylene glycol monovinyl ether, oligopropylene glycol monovinyl ether, polypropylene glycol monovinyl ether, and derivatives thereof.

Examples of the polyol compound include a polyester polyol, a polyether polyol, a polycarbonate polyol, a phenoxy resin, a polybutadiene having a hydroxyl group, and an acrylic polyol.

When the curable resin composition contains an above-described other cationically curable compound, the content of the other cationically curable compound is not particularly limited, and is preferably greater than or equal to 1 mass % and less than 50 mass %, more preferably from 5 to 40 mass %, and still more preferably from 10 to 30 mass % per the total amount (100 mass %) of the curable resin composition. When the content thereof is 1 mass % or greater, the effect from using the other cationically curable compound tends to be more easily achieved. On the other hand, when the content thereof is less than 50 mass %, a sufficient amount of the cationically polymerizable silsesquioxane can be used.

Moreover, when the curable resin composition contains the above-described other cationically curable compound, the content of the other cationically curable compound is not particularly limited, and is preferably from 5 to 50 mass %, more preferably from 10 to 40 mass %, and still more preferably from 15 to 30 mass % per the total amount (100 mass %) of the curable compounds.

The curable resin composition preferably contains a curing catalyst. The curing catalyst is a compound that can initiate and promote a polymerization reaction of the cationically polymerizable silsesquioxane and the other curable compounds. A single type of the above curing catalyst may be used alone, or two or more types may be used in combination.

The curing catalyst is selected according to the types of a curable functional group of the curable compound, and among the different types of curing catalysts, a cationic polymerization initiator or a radical polymerization initiator is preferable. The cationic polymerization initiator is a compound that generates a cationic species in response to heat or irradiation with active energy rays, and thereby initiates a curing reaction of the curable compounds.

Examples of the cationic polymerization initiator include a photocationic polymerization initiator (a photo acid generating agent) and a thermal cationic polymerization initiator (a thermal acid generating agent).

Known or commonly used photocationic polymerization initiators can be used as the photocationic polymerization initiator, and examples thereof include a sulfonium salt (a salt of a sulfonium ion and an anion), an iodonium salt (a salt of an iodonium ion and an anion), a selenium salt (a salt of a selenium ion and an anion), an ammonium salt (a salt of an ammonium ion and an anion), a phosphonium salt (a salt of a phosphonium ion and an anion), and a salt of a transition metal complex ion and an anion.

Examples of the sulfonium salt include a triarylsulfonium salt, such as a triphenylsulfonium salt, a tri-p-tolylsulfonium salt, a tri-o-tolylsulfonium salt, a tris(4-methoxyphenyl)sulfonium salt, a 1-naphthyldiphenylsulfonium salt, a 2-naphthyldiphenylsulfonium salt, a tris(4-fluorophenyl)sulfonium salt, a tri-1-naphthylsulfonium salt, a tri-2-naphthylsulfonium salt, a tris(4-hydroxyphenyl)sulfonium salt, a diphenyl[4-(phenylthio)phenyl]sulfonium salt, a 4-(p-tolylthio)phenyldi-(p-phenyl)sulfonium salt; a diarylsulfonium salt, such as a diphenylphenacylsulfonium salt, a diphenyl 4-nitrophenacylsulfonium salt, a diphenylbenzylsulfonium salt, and a diphenylmethylsulfonium salt; a monoarylsulfonium salt, such as a phenylmethylbenzylsulfonium salt, a 4-hydroxyphenylmethylbenzylsulfonium salt, and a 4-methoxyphenylmethylbenzyl sulfonium salt; and a trialkyl sulfonium salt, such as a dimethylphenacyl sulfonium salt, a phenacyl tetrahydrothiophenium salt, and a dimethyl benzylsulfonium salt.

Examples of the diphenyl[4-(phenylthio)phenyl]sulfonium salt include diphenyl[4-(phenylthio)phenyl]sulfonium tris(pentafluoroethyl)trifluorophosphate, diphenyl[4-(phenylthio)phenyl]sulfonium tetrakis(pentafluorophenyl)borate, and diphenyl[4-(phenylthio)phenyl]sulfonium hexafluorophoshate. Commercially available products can also be used, such as “CPI-101A” (trade name, diphenyl[4-(phenylthio)phenyl]sulfonium hexafluoroantimonate 50% propylene carbonate solution, available from San-Apro Ltd.) and “CPI-100P” (trade name, diphenyl[4-(phenylthio)phenyl]sulfonium hexafluorophoshate 50% propylene carbonate solution, available from San-Apro Ltd.).

Examples of the iodonium salt include “UV9380C” (trade name, a bis(4-dodecylphenyl)iodonium-hexafluoroantimonate 45% alkyl glycidyl ether solution, available from Momentive Performance Materials Japan LLC), “RHODORSIL PHOTOINITIATOR 2074” (trade name, tetrakis(pentafluorophenyl)borate-[(1-methylethyl)phenyl](methylphenyl)iodonium, available from Rhodia Japan Ltd.), “WPI-124” (trade name, available from Wako Pure Chemical Industries, Ltd.), a diphenyliodonium salt, a di-p-tolyliodonium salt, a bis(4-dodecylphenyl)iodonium salt, and a bis(4-methoxyphenyl)iodonium salt.

Examples of the selenium salt include a triarylselenium salt, such as a triphenylselenium salt, a tri-p-tolylselenium salt, a tri-o-tolylselenium salt, a tris(4-methoxyphenyl)selenium salt, and a 1-naphthyldiphenylselenium salt; a diarylselenium salt, such as a diphenylphenacylselenium salt, a diphenylbenzylselenium salt, and a diphenylmethylselenium salt; a monoarylselenium salt, such as a phenylmethylbenzylselenium salt; and a trialkylselenium salt, such as a dimethylphenacylselenium salt.

Examples of the ammonium salt include a tetraalkyl ammonium salt, such as a tetramethyl ammonium salt, an ethyltrimethyl ammonium salt, a diethyldimethyl ammonium salt, a triethylmethyl ammonium salt, a tetraethyl ammonium salt, a trimethyl-n-propyl ammonium salt, and a trimethyl-n-butyl ammonium salt; a pyrrolidium salt, such as an N,N-dimethylpyrrolidium salt and an N-ethyl-N-methylpyrrolidium salt; an imidazolinium salt, such as an N,N′-dimethylimidazolinium salt and an N,N′-diethylimidazolinium salt; a tetrahydropyrimidium salt, such as an N,N′-dimethyltetrahydropyrimidium salt and an N,N′-diethyltetrahydropyrimidium salt; a morpholinium salt, such as an N,N-dimethylmorpholinium salt and an N,N-diethylmorpholinium salt; a piperidinium salt, such as an N,N-dimethylpiperidinium salt and an N,N-diethylpiperidinium salt; a pyridinium salt, such as an N-methylpyridinium salt and an N-ethylpyridinium salt; an imidazolium salt, such as an N,N′-dimethylimidazolium salt; a quinolium salt, such as an N-methylquinolium salt; an isoquinolium salt, such as an N-methylisoquinolium salt; a thiazonium salt, such as a benzylbenzothiazonium salt; and an acrydium salt, such as a benzylacrydium salt.

Examples of the phosphonium salt include a tetra-arylphosphonium salt, such as a tetra-phenylphosphonium salt, a tetra-p-tolylphosphonium salt, and a tetrakis(2-methoxyphenyl)phosphonium salt; a triarylphosphonium salt, such as a triphenylbenzylphosphonium salt; and a tetra-alkylphosphonium salt, such as a triethylbenzylphosphonium salt, a tributylbenzylphosphonium salt, a tetra-ethylphosphonium salt, a tetra-butylphosphonium salt, and a triethylphenacylphosphonium salt.

Examples of the salt of a transition metal complex ion include a salt of a chromium complex cation, such as (η⁵-cyclopentadienyl)(η⁶-toluene)Cr⁺ and (η⁵-cyclopentadienyl)(η⁶-xylene)Cr⁺; and a salt of an iron complex cation, such as (η⁵-cyclopentadienyl)(η⁶-toluene)Fe⁺ and (η⁵-cyclopentadienyl)(η⁶-xylene)Fe⁺.

Examples of anions constituting the above-described salts include SbF₆⁻, PF₆⁻, BF4⁻, (CF₃CF₂)₃PF₃⁻, (CF₃CF₂CF₂)₃PF₃⁻, (C₆F₅)₄B⁻, (C₆F₅)₄Ga⁻, a sulfonate anion (such as a trifluoromethane sulfonate anion, a pentafluoroethane sulfonate anion, a nonafluorobutane sulfonate anion, a methane sulfonate anion, a benzene sulfonate anion, and a p-toluene sulfonate anion), (CF₃SO₂)₃C⁻, (CF₃SO₂)₂N⁻, a perhalogenate ion, a halogenated sulfonate ion, a sulfate ion, a carbonate ion, an aluminate ion, a hexafluorobismuthate ion, a carboxylate ion, an arylborate ion, a thiocyanate ion, and a nitrate ion.

Examples of the thermal cationic polymerization initiator include an arylsulfonium salt, an aryliodonium salt, an allene-ion complex, a quaternary ammonium salt, an aluminum chelate, and a boron trifluoride amine complex. Examples of anions constituting the above-described salts include the same examples as the anions of the photocationic polymerization initiators described above.

Examples of the arylsulfonium salt include a hexafluoroantimonate salt and the like. In the curable resin composition according to an embodiment of the present invention, commercially available products such as “SP-66” and “SP-77” (trade names, available from ADEKA Corporation); “SAN-AID SI-60L”, “SAN-AID SI-60S”, “SAN-AID SI-80 L”, “SAN-AID SI-100L” and “SAN-AID SI-150 L” (trade names, available from Sanshin Chemical Industry Co., Ltd.) can be used. Examples of the aluminum chelate include ethylacetoacetate aluminum diisopropylate and aluminum tris(ethylacetoacetate). Moreover, examples of the boron trifluoride amine complex include a boron trifluoride monoethyl amine complex, a boron trifluoride imidazole complex, and a boron trifluoride piperidine complex.

The radical polymerization initiator is a compound that generates radicals in response to heat or irradiation with active energy rays, and thereby initiates a curing reaction of the curable compound.

Examples of the radical polymerization initiator include a photoradical polymerization initiator and a thermal radical polymerization initiator. Examples of the photoradical polymerization initiator include an alkylphenone-based photoradical polymerization initiator, an acylphosphine oxide-based photoradical polymerization initiator, an oxime ester-based photoradical polymerization initiator, and an a-hydroxyketone-based photoradical polymerization initiator.

Examples of the alkylphenone-based photoradical polymerization initiator include oligomers of 2-hydroxy-2-methyl-1-phenylpropan-1-one, 2-benzyl-2-dimethylamino-1-(4-morpholinophenyl)-1-butanone, 2-(dimethylamino)-2-[(4-methylphenyl)methyl]-[4-(4-morpholinyl)phenyl]-1-butanone, 2-methyl-1-[4-(methylthio)phenyl]-2-morpholinopropan-1-one, benzophenone, methylbenzophenone, o-benzoylbenzoic acid, benzoylethyl ether, 2,2-diethoxyacetophenone, 2,4-diethylthioxanthone, diphenyl-(2,4,6-trimethylbenzoyl)phosphineoxide, ethyl-(2,4,6-trimethylbenzoyl)phenylphosphinate, 4,4′-bis(diethylamino)benzophenone, 1-hydroxycyclohexylphenyl ketone, 2,2-dimethoxy-1,2-diphenylethan-1-one, 1-[4-(2-hydroxyethoxy)phenyl]-2-hydroxy-2-methyl-1-propan-1-one, and 2-hydroxy-1-(4-isopropenylphenyl)-2-methylpropan-1-one.

Examples of the acylphosphine oxide-based photoradical polymerization initiators include 2,4,6-trimethylbenzoyl diphenylphosphine oxide and bis(2,4,6-trimethylbenzoyl)phenylphosphine oxide.

Examples of the oxime ester-based photoradical polymerization initiator include 1-[4-(phenylthio)phenyl]-1,2-octandione 2-(O-benzoyloxime) and 1-[6-(2-methylbenzoyl)-9-ethyl-9H-carbazol-3-yl]ethanone O-acetyloxime.

Examples of the a-hydroxyketone-based photoradical polymerization initiator include benzoin, benzoin methyl ether, benzoin butyl ether, 1-hydroxycyclohexylphenyl ketone, 1-phenyl-2-hydroxy-2-methylpropan-1-one, 1-(4-1-propylphenyl)-2-hydroxy-2-methylpropan-1-one, 4-(2-hydroxyethoxy)phenyl-(2-hydroxy-2-propyl)ketone, and 1-hydroxycyclohexylphenyl ketone.

The content (blending amount) of the curing catalyst in the curable resin composition is not particularly limited, but is preferably from 0.01 to 10 parts by mass, more preferably from 0.03 to 5 parts by mass, and still more preferably from 0.05 to 3 parts by mass, per 100 parts by mass of the total amount of the curable compounds. When the content of the curing catalyst is 0.01 parts by mass or greater, the curing reaction can be efficiently and sufficiently advanced, and the surface hardness of the coating layer tends to further improve. On the other hand, when the content of the curing catalyst is 10 parts by mass or less, the storage properties of the curable resin composition tend to improve, and coloration of the cured product tends to be inhibited.

The curable resin composition may further include, as other components, commonly used additives, such as a curing agent, a curing auxiliary, an inorganic filler, such as precipitated silica, wet silica, fumed silica, calcined silica, titanium oxide, alumina, glass, quartz, aluminosilicic acid, iron oxide, zinc oxide, calcium carbonate, carbon black, silicon carbide, silicon nitride, and boron nitride, an inorganic filler produced by treating the above filler with an organosilicon compound, such as an organohalosilane, an organoalkoxysilane, and an organosilazane; a filler, such as a conductive metal powder of silver, copper, or the like, a curing auxiliary, a stabilizer (such as a light-resistant stabilizer, a heat stabilizer, and a heavy metal inactivator), an ultraviolet absorber (a triazine-based UV absorber, a benzotriazole-based UV absorber, a benzophenone-based UV absorber, an oxybenzophenone-based UV absorber, a salicylate-based UV absorber, and a cyanoacrylate-based UV absorber), a flame retardant (such as a phosphorus-based flame retardant, a halogen-based flame retardant, and an inorganic flame retardant), a flame retardant auxiliary, a reinforcing material (such as an additional filler), a nucleating agent, a coupling agent (such as a silane coupling agent), a lubricant, a wax, a plasticizer, a releasing agent, an impact modifier, a hue modifier, a transparentizing agent, a rheology modifier (such as a fluidity modifier), a processability modifier, a colorant (such as a dye and a pigment), an antistatic agent, a dispersant, a surface modifier (such as a slipping agent), a matting agent, an antifoaming agent, a foam inhibitor, a deforming agent, an antibacterial agent, a preservative, a viscosity modifier, a thickening agent, a photosensitizer, and a foaming agent. A single type of the other components may be used alone, or two or more types may be used in combination. The content of the other components described above is not particularly limited, but is preferably from 100 parts by mass or less, more preferably from 30 parts by mass or less (for example, from 0.01 to 30 parts by mass), and still more preferably 10 parts by mass or less (for example, from 0.1 to 10 parts by mass), per 100 parts by mass of the total amount of the curable compounds.

The content of the antimony compound in the curable resin composition is preferably 1000 ppm by mass or less per the total amount (100 mass %) of the curable resin composition. When the content of the antimony compound in the curable resin composition is 1000 ppm by mass or less, more excellent safety can be achieved. Moreover, the lower limit is not particularly limited, and may be 0 ppm by mass.

The above-described curable resin composition can be prepared by agitating and mixing components described above at room temperature or under heating as necessary, but the preparation method is not limited thereto. Here, the curable resin composition can be used as a one-part composition that contains components mixed in advance and is used as is, or alternatively, the curable resin composition can be used as a multi-part (for example, two-part) composition, two or more components of which are separately stored and then mixed at predetermined proportions before use.

The form of the curable resin composition is not particularly limited but is preferably a liquid at ambient temperature (about 25° C.). More specifically, the viscosity of the curable resin composition at 25° C. is preferably 15 mPa·s or less, more preferably 12 mPa·s or less, and even more preferably 10 mPa·s or less. When the viscosity is 15 mPa·s or less, the curable resin composition can be uniformly applied onto the substrate as a thin film (thickness uniformity can be exhibited), and optical properties can be easily exhibited. On the other hand, the lower limit is not particularly limited, but is preferably, for example, 0.5 mPa·s or greater.

### Coating Layer

One embodiment of present disclosure is a coating layer including a cured product of the above-described curable resin composition.

The method for producing the coating layer is not particularly limited, and the coating layer can be produced in accordance with a known or commonly used method for producing a coating layer. For example, the coating layer can be produced by coating at least one surface of the cycloolefin-based copolymer substrate with the curable resin composition, and then curing the curable resin composition while removing the solvent through heating and drying, as necessary. The application method and curing conditions for the curable resin composition are not particularly limited, and for example, can be appropriately selected from the below-described conditions.

As a method for applying and curing the coating layer, an ordinary coating method can be used. For example, a known method such as a dipping, roll coating, gravure coating, inkjet coating, spin coating, reverse coating, air knife coating, comma coating, die coating, screen printing, spray coating, gravure offset, and organic vapor deposition can be used.

An example of the curing method in a case in which a photocurable catalyst is used in the curable resin composition is irradiation with light using, for example, a mercury lamp, a xenon lamp, a carbon arc lamp, a metal halide lamp, sunlight, an electron beam source, a laser light source, or an LED light source. Also note that when the coating layer is cured by irradiation with ultraviolet rays, for example, the cumulative irradiation amount is preferably from approximately 1 mJ/cm² to approximately 5000 mJ/cm².

The specific curing conditions are not particularly limited, but for example, the curable resin composition is first subjected to a heat treatment (pre-baking) at a temperature of preferably 60° C. or higher, more preferably 120° C. or higher, and even more preferably 150° C. or higher for preferably 10 seconds or longer, more preferably 30 seconds or longer, and even more preferably 60 seconds or longer, and is then irradiated with ultraviolet rays (radiation conditions (radiation dose): preferably 300 mJ/cm² or greater; radiation intensity: 100 mW/cm² or greater), and finally, is cured through heat treatment (aging) at a temperature of preferably 120° C. or higher for preferably 0.5 hours or longer.

When a thermosetting catalyst is used as the curing method, the specific heating temperature is preferably from 100 to 200° C., and more preferably from 110 to 170° C. The heating time is preferably from 30 minutes to 6 hours, and more preferably from 1 to 4 hours. Note that the heating temperature and the heating time can be changed, as appropriate. Moreover, the curing conditions are not limited to these ranges, and the pre-baking temperature and time, and the aging temperature and time can be selected, as appropriate, according to the solvent that is used. Moreover, the ultraviolet radiation conditions can also be selected, as appropriate, according to the curing catalyst that is used.

As described above, through application and curing, the curable resin composition can exhibit high adherence to the cycloolefin-based copolymer substrate as a single layer without using another adhesive layer, and can form a coating layer having high surface hardness and high moisture resistance.

The thickness of the coating layer is preferably from 0.1 to 10 m, and more preferably from 0.3 to 5 m. When the thickness of the coating layer is 0.1 m or greater, the performance as a coating layer can be exhibited. In addition, when the thickness of the coating layer is 10 m or less, the curable resin composition is easily applied as a thin film having high level of smoothness.

### Laminate

An example of another embodiment of the present disclosure is a laminate in which the coating layer is formed on at least one surface of a cycloolefin-based copolymer substrate. Since the laminate includes the coating layer including a cured product of the curable resin composition, the laminate has sufficient adherence to the cycloolefin-based copolymer substrate and can exhibit moisture resistance while increasing the surface hardness. The coating layer may be provided on only one surface of the cycloolefin-based copolymer substrate, or may be provided on both surfaces. When the coating layer is provided on each of both surfaces of the cycloolefin-based copolymer substrate, coating layers having the same composition and thickness may be provided on the respective surfaces, or coating layers having different compositions and thicknesses may be provided on the respective surfaces.

In addition, the laminate may contain other layers in addition to the substrate and the coating layer, or may not contain other layers from the viewpoint of application with a thin film. Examples of the other layers include an undercoat layer and an antireflection layer. Here, the other layers may be formed on only one surface of the cycloolefin-based copolymer substrate, or may be formed on both surfaces thereof. In addition, when the other layers are formed on both surfaces of the cycloolefin-based copolymer substrate, the same layers may be laminated on each surface, or layers having different thicknesses or compositions may be laminated on the surfaces of the substrate.

Examples of the cycloolefin-based copolymer used in the cycloolefin-based copolymer substrate include a cycloolefin polymer (COP) and a cycloolefin copolymer (COC). A single type of cycloolefin-based copolymer may be used alone, or two or more types may be used in combination.

The cycloolefin polymer (COP) is a polymer having a constituent unit derived from a cyclic olefin on the main chain and/or a side chain. The cyclic olefin is not particularly limited, and may be a polycyclic olefin or a monocyclic olefin. Examples of the polycyclic olefin include a norbornene compound such as norbornene, methyl norbornene, dimethyl norbornene, ethyl norbornene, ethylidene norbornene, and butyl norbornene; a dicyclopentadiene compound such as dicyclopentadiene, dihydrodicyclopentadiene, methyldicyclopentadiene, and dimethyldicyclopentadiene; tetracyclododecene, methyltetracyclododecene, dimethylcyclotetradodecene, tricyclopentadiene, and tetracyclopentadiene. Examples of the monocyclic olefin include cyclobutene, cyclopentene, cyclooctene, cyclooctadiene, cyclooctatriene, and cyclododecatriene.

The cycloolefin copolymer (COC) is a polymer having a constituent unit derived from a cyclic olefin as described above and a constituent unit derived from an acyclic olefin such as ethylene or an α-olefin. Examples of the α-olefin include a linear α-olefin having from 3 to 20 carbons such as propylene, 1-butene, 1-pentene, 1-hexene, 1-octene, 1-decene, 1-dodecene, 1-tetradecene, 1-hexadecene, 1-octadecene, and 1-eicosene; and a branched α-olefin having from 4 to 20 carbons such as 4-methyl-1-pentene, 3-methyl-1-pentene, and 3-methyl-1-butene.

The content of the cycloolefin-based copolymer in the cycloolefin-based copolymer substrate is not particularly limited, but is preferably 80 mass % or greater, and more preferably 90 mass % or greater per the total amount (100 mass %) of the substrate. Moreover, the upper limit is not particularly limited and may be 100 mass %.

If necessary, the cycloolefin-based copolymer substrate may further contain other components such as a resin, a flame retardant, an antioxidant, a light stabilizer, a metal deactivator, a plasticizer, a nucleating agent, a transparentizing agent, an antistatic agent, and a lubricant, with the other components being components other than those exemplified above.

The form of the cycloolefin-based copolymer substrate is not particularly limited, and examples thereof include a substrate for a film and a substrate for a lens. When the cycloolefin-based copolymer substrate is a substrate for a film, the thickness of the cycloolefin-based copolymer substrate is preferably from 1 to 200 μm, more preferably from 3 to 100 μm, and still more preferably from 5 to 50 μm. When the cycloolefin-based copolymer substrate is a substrate for a lens, the thickness of the cycloolefin-based copolymer substrate is preferably from 500 to 5000 μm, more preferably from 700 to 4500 μm, and still more preferably from 1000 to 4000 μm. When the substrate is a substrate for a film, the substrate can be molded and produced by a melt extrusion molding method, a solution casting method, or the like, and when the substrate is a substrate for a lens, the substrate can be produced by an injection molding method, a compression molding method, a transfer molding method, an injection compression molding method, or the like.

In accordance with JIS K5600 5-6:1999, when cuts are made at intervals of 1 mm on the laminate from the coating layer side with a cutter blade to form a lattice pattern of 100 squares, an adhesive tape is attached and peeled off at an angle of 90°, and whether the coating layer surface is peeled off after attaching to the adhesive tape is observed, preferably 70 or more squares, more preferably 90 or more squares, and particularly preferably 100 squares remain intact. The sufficient adherence of the coating layer to the cycloolefin-based copolymer substrate can be confirmed when 70 or more squares remain intact on the substrate. Note that when the coating layer is laminated on both surfaces of the substrate, the above range need only be satisfied on at least one surface.

The laminate preferably does not exhibit any whitening or cracking after a pressure cooker test (PCT) in which the laminate is stored for 8 hours in a constant temperature and constant humidity chamber under conditions including a temperature of 120° C. and 100% RH. Note that when the coating layer is laminated on both surfaces of the substrate, the above requirements need only be satisfied on at least one surface.

The arithmetic mean height (Sa) of the coating layer in the laminate is preferably 30 m or less, more preferably 25 m or less, and even more preferably 20 m or less. When the arithmetic mean height is 30 m or less, film thickness uniformity is easily improved. In addition, the lower limit of the arithmetic mean height (Sa) is not particularly limited but is, for example, 0.1 m or greater. Note that when the coating layer is laminated on both surfaces of the substrate, the above range need only be satisfied on at least one surface.

When a film substrate is used as the cycloolefin-based copolymer substrate, the thickness of the laminate is preferably from 1 to 200 m, more preferably from 3 to 100 m, and still more preferably from 5 to 50 m. When a substrate for a lens is used as the cycloolefin-based copolymer substrate, that is, when the laminate is a plastic lens, the thickness of the laminate is preferably from 500 to 5000 m, more preferably from 700 to 4500 m, and still more preferably from 1000 to 4000 jm.

In addition, since the laminate has improved surface hardness by applying a coating layer having a high level of adherence to the cycloolefin-based copolymer substrate having excellent physical properties such as moisture resistance, the laminate can be suitably used as a plastic lens or an image display device.

Each aspect disclosed in the present specification can be combined with any other feature disclosed herein. Moreover, each of the configurations, combinations thereof, and the like in each of the embodiments are merely examples, and various additions, omissions, and other changes of the configurations may be made, as appropriate, without departing from the spirit of the present disclosure. The present disclosure is not limited by the embodiments and is limited only by the claims.

### EXAMPLES

An embodiment of the present disclosure will be described in detail below based on Examples. Unless otherwise specified, the units of the numerical values described in the table are parts by mass.

### Production Example 1

### Production of Cationically Polymerizable Silsesquioxane

A 1000 mL flask (reaction vessel) equipped with a thermometer, a stirrer, a reflux condenser, and a nitrogen inlet tube was charged with 277.2 mmol (68.30 g) of 2-(3,4-epoxycyclohexyl)ethyltrimethoxysilane, 3.0 mmol (0.56 g) of phenyltrimethoxysilane, and 275.4 g of acetone under a nitrogen stream, and the temperature was raised to 50° C. To the mixture thus prepared, 7.74 g of a 5% potassium carbonate aqueous solution (2.8 mmol as potassium carbonate) was added over 5 minutes, after which 2800.0 mmol (50.40 g) of water was added over 20 minutes. Here, no significant temperature increase occurred during the additions. Subsequently, a polycondensation reaction was performed under a nitrogen stream for 5 hours while the temperature was maintained at 50° C.

Next, the reaction solution was cooled, and simultaneously, 137.70 g of methyl isobutyl ketone and 100.60 g of a 5% saline solution were added thereto. The solution was transferred to a 1 L separation funnel, and then 137.70 g of methyl isobutyl ketone was again added, and rinsing with water was performed. After the separation, the water layer was removed, and the lower layer liquid was rinsed with water until the lower layer liquid became neutral. The upper layer liquid was then fractioned, after which the solvent was distilled away from the upper layer liquid at a pressure of 1 mmHg and a temperature of 50° C., and 75.18 g of a colorless, transparent liquid product (an epoxy group-containing low-molecular weight polyorganosilsesquioxane:silsesquioxane) containing 23 mass % of methyl isobutyl ketone was provided.

Note that when the product was analyzed, the number average molecular weight was found to be 2235, and the molecular weight dispersity was 1.54. A ratio [T3 form/T2 form] of T2 forms and T3 forms calculated from the ²⁹Si-NMR spectrum of the product was 11.9. The resulting epoxy group-containing low-molecular weight polyorganosilsesquioxane was confirmed through ¹H-NMR and ²⁹Si-NMR.

The molecular weight of the product was measured using the Shimadzu LC-20AD pump, the Shodex RI-504 detector, the Shodex GPC KF-602 and KF-603 columns, the Shodex GPC KF-G guard column, and THE as the solvent at a measurement temperature condition of 40° C. In addition, the ratio [T3 form/T2 form] of T2 forms and T3 forms in the product was measured through ²⁹Si-NMR spectrum measurements using the JEOL ECA500 (500 MHz).

### Examples 1 to 13 and Comparative Examples 1 to 6

Mixed solutions having the compounding proportions shown in Table 1 were prepared and used as curable resin compositions of the Examples and Comparative Examples. The curable resin composition was applied onto the surface of a cycloolefin-based copolymer substrate (trade name “TOPAS”, available from Polyplastics Co., Ltd., thickness: 2000 m, COC substrate) and (a ring-opening metathesis polymer of norbornenes, thickness: 2000 m, COP substrate) using a wire bar #5, with the curable resin composition being applied at an amount resulting in a thickness of about 1 m after curing, after which the coated substrate was heat treated in an oven at 100° C. for 2 hours, and thereby coating layers of the Examples and Comparative Examples were prepared.

### Comparative Example 7

A mixed solution having the compounding proportion shown in Table 1 was prepared and used as the curable resin composition of Comparative Example 7. The curable resin composition was applied onto the surface of a cycloolefin-based copolymer (trade name “TOPAS”, available from Polyplastics Co., Ltd., thickness: 2000 m, COC substrate) and (a ring-opening metathesis polymer of norbornenes, thickness: 2000 m, COP substrate) using a wire bar #5 so that a thickness of the cured composition was about 1 m, after which coated substrate was heat treated in an oven at 100° C. for 1 hour, and then in an oven at 120° C. for 2 hours, and thereby a coating layer of Comparative Example 7 was prepared.

### Comparative Example 8

A mixed solution having the compounding proportion shown in Table 1 was prepared and used as the curable resin composition of Comparative Example 8. The curable resin composition was applied onto the surface of a cycloolefin-based copolymer (trade name “TOPAS”, available from Polyplastics Co., Ltd., thickness: 2000 m, COC substrate) and (a ring-opening metathesis polymer of norbornenes, thickness: 2000 m, COP substrate) using a wire bar #5 so that a thickness of the cured composition was about 1 m, after which coated substrate was heat treated in an oven at 120° C. for 2 hours, and thereby a coating layer of Comparative Example 8 was prepared.

Components listed in Table 1 are described in detail below.
POSS101: trade name “POSS101”, available from Construe Chemical Co., Ltd. (glycidyl epoxy organosiloxane)
OX-SQ: trade name “OX-SQ”, available from Toagosei Co., Ltd. (oxetane organosilsesquioxane)
KR-470: trade name “KR-470”, available from Shin-Etsu Chemical Co., Ltd. (cyclic epoxy silicone resin)
Celloxide 2021P: trade name “Celloxide 2021P”, available from Daicel Corporation (alicyclic epoxy resin)
YD-128: trade name “YD-128”, available from Nippon Steel Chemical & Material Co., Ltd. (bisphenol A epoxy resin)
KER-2500A: available from Shin-Etsu Chemical Co., Ltd. (two-part addition-curable silicone resin)
KER-2500B: available from Shin-Etsu Chemical Co., Ltd. (two-part addition-curable silicone resin)
OE-6630A: available from Dow Toray Co., Ltd. (two-part liquid silicone resin)
OE-6630B: available from Dow Toray Co., Ltd. (two-part liquid silicone resin)
SI-100L: trade name “SI-100L”, available from Sanshin Chemical Industry Co., Ltd. (thermal polymerization initiator)

### Evaluation

The curable resin compositions and coating layers of Examples and Comparative Examples were subjected to the following evaluations, and the results are presented in Table 1.

### (1) Viscosity

About 1.1 mL of the curable resin composition of each of Examples and Comparative Examples was collected, and the viscosity was measured at a temperature of 25° C. using an E-type viscometer (trade name “TV-25”, available from Toki Sangyo Co., Ltd.). The average value of the results of two measurements was taken as the viscosity of each curable resin composition.

### (2) Adherence Test

In accordance with JIS K5600 5-6: 1999, cuts were made at intervals of 1 mm on the coating layer surface of each of Examples and Comparative Examples with a cutter blade to form a lattice pattern of 100 squares. Next, an adhesive tape was attached and peeled off at an angle of 90°, and whether the coating surfaces were peeled off after attaching to the adhesive tape was observed. A case in which 90 or more squares remained adhered was evaluated as being excellent, a case in which 70 or more squares and less than 90 squares remained was evaluated as being good, and a case in which fewer than 70 squares remained was evaluated as being poor.

### (3) PCT Test (Pressure Cooker Test)

A coating layer that was evaluated as good or higher in the adherence test was inserted into a pressure cooker test apparatus (trade name “EHS-411M”, available from ESPEC Corp.) and stored in a constant temperature and constant humidity chamber at 120° C. and 100% RH for 8 hours. The change in appearance after removal was visually observed, and a case in which there was no change in appearance was evaluated as being good, and a case in which whitening or wrinkling occurred was evaluated as being poor.

### (4) Arithmetic Mean Height (Sa)

In accordance with ISO 25178, the sample was placed on a test table of a laser microscope (trade name “VK-8710”, available from Keyence Corporation), and the arithmetic roughness of the coating layer surface was measured using a 10×/0.30 OFN25 lens (WP 16.5) available from Nikon Corporation. The arithmetic mean height of the coating layer was calculated for a sample size of 200 μm×200 μm. Ten test results were obtained, and the mean value of the six middle test results was used as the arithmetic mean height.

TABLE 1

| | | Example | Example | Example | Example | Example | Example | Example | Example | Example |
|---|---|---|---|---|---|---|---|---|---|---|
| | | 1 | 2 | 3 | 4 | 5 | 6 | 7 | 8 | 9 |
| Resin | Silsesquioxane | 100 | 100 | 100 | 100 | | | | | |
| | POSS101 | | | | | 100 | 100 | | | |
| | OX-SQ | | | | | | | 100 | 100 | 100 |
| | KR-470 | | | | | | | | | |
| | Celloxide | | | | | | | | | |
| | 2021P | | | | | | | | | |
| | YD-128 | | | | | | | | | |
| | KER-2500A | | | | | | | | | |
| | KER-2500B | | | | | | | | | |
| | OE-6630A | | | | | | | | | |
| | OE-6630B | | | | | | | | | |
| Solvent | Cyclohexanone | 350 | | | 175 | 380 | | 380 | | |
| | Cyclopentyl | | 350 | | | | | | 380 | |
| | methyl ether | | | | | | | | | |
| | Cyclopentanone | | | 350 | 175 | | 380 | | | 380 |
| | 4-methyl-2- | 30 | 30 | 30 | 30 | | | | | |
| | pentanone | | | | | | | | | |
| | Ethyl methyl | | | | | | | | | |
| | ketone | | | | | | | | | |
| Catalyst | SI-100L | 0.19 | 0.19 | 0.19 | 0.19 | 0.19 | 0.19 | 0.19 | 0.19 | 0.19 |
| Viscosity (mPa · s) | | 4.7 | 1.2 | 3.2 | 2.5 | 5.6 | 3.2 | 4.7 | 1.1 | 2.3 |
| Adherence | Adherence to | Excellent | Excellent | Excellent | Excellent | Excellent | Excellent | Excellent | Excellent | Excellent |
| Test | COC substrate | | | | | | | | | |
| | Adherence to | Excellent | Excellent | Excellent | Good | Good | Good | Good | Good | Good |
| | COP substrate | | | | | | | | | |

| | | | | | | | | | |
|---|---|---|---|---|---|---|---|---|---|
| PCT test | Good | Good | Good | Good | Good | Good | Good | Good | Good |
| Arithmetic mean height | 2.25 | 2.74 | 2.26 | — | — | — | — | — | — |
| (Sa)(μm) | | | | | | | | | |

| | | Example | Example | Example | Example | Comparative | Comparative | Comparative |
|---|---|---|---|---|---|---|---|---|
| | | 10 | 11 | 12 | 13 | Example 1 | Example 2 | Example 3 |
| Resin | Silsesquioxane | | | | 100 | | | |
| | POSS101 | | | | | | | |
| | OX-SQ | | | | | | | |
| | KR-470 | 100 | 100 | 100 | | | | |
| | Celloxide | | | | | 100 | 100 | |
| | 2021P | | | | | | | |
| | YD-128 | | | | | | | 100 |
| | KER-2500A | | | | | | | |
| | KER-2500B | | | | | | | |
| | OE-6630A | | | | | | | |
| | OE-6630B | | | | | | | |
| Solvent | Cyclohexanone | 350 | | | | | | |
| | Cyclopentyl | | 350 | | | 380 | | 380 |
| | methyl ether | | | | | | | |
| | Cyclopentanone | | | 350 | 30 | | 380 | |
| | 4-methyl-2- | 30 | 30 | 30 | 30 | | | |
| | pentanone | | | | | | | |
| | Ethyl methyl | | | | | | | |
| | ketone | | | | | | | |
| Catalyst | SI-100L | 0.19 | 0.19 | 0.19 | 0.19 | 0.19 | 0.19 | 0.19 |
| Viscosity (mPa · s) | | 2.7 | 0.7 | 1.7 | 113.4 | 0.8 | 1.8 | 1 |
| Adherence | Adherence to | Excellent | Excellent | Excellent | Excellent | Excellent | Excellent | Excellent |
| Test | COC substrate | | | | | | | |
| | Adherence to | Good | Good | Good | Excellent | Excellent | Excellent | Poor |
| | COP substrate | | | | | | | |

| | | | | | | | |
|---|---|---|---|---|---|---|---|
| PCT test | Good | Good | Good | Excellent | Poor | Poor | Poor |
| Arithmetic mean height | — | — | — | 103.5 | — | — | — |
| (Sa)(μm) | | | | | | | |

| | | Comparative | Comparative | Comparative | Comparative | Comparative |
|---|---|---|---|---|---|---|
| | | Example 4 | Example 5 | Example 6 | Example 7 | Example 8 |
| Resin | Silsesquioxane | | 100 | 100 | | |
| | POSS101 | | | | | |
| | OX-SQ | | | | | |
| | KR-470 | | | | | |
| | Celloxide | | | | | |
| | 2021P | | | | | |
| | YD-128 | 100 | | | | |
| | KER-2500A | | | | 50 | |
| | KER-2500B | | | | 50 | |
| | OE-6630A | | | | | 20 |
| | OE-6630B | | | | | 80 |
| Solvent | Cyclohexanone | | | | | |
| | Cyclopentyl | | | | | |
| | methyl ether | | | | | |
| | Cyclopentanone | 380 | | | 380 | 380 |
| | 4-methyl-2- | | 380 | 30 | | |
| | pentanone | | | | | |
| | Ethyl methyl | | | 350 | | |
| | ketone | | | | | |
| Catalyst | SI-100L | 0.19 | 0.19 | 0.19 | | |
| Viscosity (mPa · s) | | 2 | 1.2 | 0.7 | 2 | 1.6 |
| Adherence | Adherence to | Excellent | Good | Good | Poor | Poor |
| Test | COC substrate | | | | | |
| | Adherence to | Poor | Poor | Poor | Poor | Poor |
| | COP substrate | | | | | |

| | | | | | |
|---|---|---|---|---|---|
| PCT test | — | — | — | — | — |
| Arithmetic mean height | — | — | — | — | — |
| (Sa)(μm) | | | | | |

It was confirmed in Examples that when the curable resin composition contains an alicyclic ketone compound and/or an alicyclic ether compound, and a cationically polymerizable silsesquioxane and/or a cationically polymerizable cyclic siloxane, the curable resin composition could be applied as a single layer coating, exhibited sufficient adherence to a cycloolefin-based copolymer substrate, and was excellent in moisture resistance. On the other hand, when neither the cationically polymerizable silsesquioxane nor the cationically polymerizable cyclic siloxane was used, the moisture resistance was inferior or sufficient adherence to the cycloolefin-based copolymer substrate could not be exhibited (Comparative Examples 1 to 4, Comparative Examples 7 and 8). In addition, when neither the alicyclic ketone compound nor the alicyclic ether compound was used, adherence to the cycloolefin-based copolymer substrate could not be exhibited (Comparative Examples 5 and 6).

Hereinafter, variations of the invention according to the present disclosure will be described.

### [Addendum 1]

A curable resin composition for coating a cycloolefin-based copolymer substrate, the curable resin composition containing:
an alicyclic ketone compound and/or an alicyclic ether compound; and
a cationically polymerizable silsesquioxane and/or a cationically polymerizable cyclic siloxane.

### [Addendum 2]

The curable resin composition according to addendum 1, wherein the curable resin composition has a viscosity of 15 mPa·s or less at 25° C.

### [Addendum 3]

The curable resin composition according to addendum 1 or 2, wherein the alicyclic ketone compound is cyclohexanone or cyclopentanone, and the alicyclic ether compound is cyclopentyl methyl ether.

### [Addendum 4]

The curable resin composition according to any one of addenda 1 to 3, wherein a cationically polymerizable functional group of the cationically polymerizable silsesquioxane has a cyclic ether structure.

### [Addendum 5]

A coating layer including a cured product of the curable resin composition described in any one of addenda 1 to 4.

### [Addendum 6]

A laminate including the coating layer described in addendum 5 laminated on at least one cycloolefin-based copolymer substrate.

### [Addendum 7]

The laminate according to addendum 6, wherein when 100 squares are formed on the coating layer in a lattice shape at 1 mm intervals, an adhesive tape is affixed thereto, and the adhesive tape is peeled off in a direction of 90°, 90 or more squares remain.

### [Addendum 8]

The laminate according to addendum 6 or 7, wherein an arithmetic mean height (Sa) of the coating layer is 30 μm.

### [Addendum 9]

The laminate according to any one of addenda 6 to 8, wherein the cycloolefin-based copolymer substrate is a substrate for a lens.

### [Addendum 10]

A plastic lens provided with the laminate described in addendum 9.

### [Addendum 11]

An image display device provided with the laminate described in any one of addenda 6 to 9.

1. A curable resin composition for coating a cycloolefin-based copolymer substrate, the curable resin composition comprising:
an alicyclic ketone compound and/or an alicyclic ether compound; and
a cationically polymerizable silsesquioxane and/or a cationically polymerizable cyclic siloxane.

2. The curable resin composition according to claim 1, wherein the curable resin composition has a viscosity of 15 mPa·s or less at 25° C.

3. The curable resin composition according to claim 1, wherein the alicyclic ketone compound is cyclohexanone or cyclopentanone, and the alicyclic ether compound is cyclopentyl methyl ether.

4. The curable resin composition according to claim 1, wherein a cationically polymerizable functional group of the cationically polymerizable silsesquioxane has a cyclic ether structure.

5. A coating layer comprising a cured product of the curable resin composition described in claim 1.

6. A laminate comprising the coating layer described in claim 5 laminated on at least one cycloolefin-based copolymer substrate.

7. The laminate according to claim 6, wherein when cuts are made at intervals of 1 mm to form a lattice pattern of 100 squares on the coating layer, an adhesive tape is attached and peeled off at an angle of 90°, 90 or more squares remain intact.

8. The laminate according to claim 6, wherein an arithmetic mean height (Sa) of the coating layer is 30 μm or less.

9. The laminate according to claim 6, wherein the cycloolefin-based copolymer substrate is a substrate for a lens.

10. A plastic lens comprising the laminate described in claim 9.

11. An image display device comprising the laminate described in claim 6.
